(19) United States
(12) Patent Application Publication
(10) Pub. No.: US 2025/0005742 A1
(43) Pub. Date: Jan. 2, 2025

(54) INSPECTION DEVICE, CONTROL METHOD FOR INSPECTION DEVICE, AND INSPECTION SYSTEM

(71) Applicant: CANON KABUSHIKI KAISHA, Tokyo (JP)

(72) Inventor: ASAKO SUGAHARA, Chiba (JP)

(21) Appl. No.: 18/757,270

(22) Filed: Jun. 27, 2024

(30) Foreign Application Priority Data
Jun. 28, 2023 (JP) 2023-105938

(51) Int. Cl. G06T 7/00

(52) U.S. Cl. CPC G06T 7/001; G06T 2207/30144

(57) ABSTRACT

On registered reference image data, a first region for conducting a matching inspection is set, and, upon receiving an instruction for a matching inspection, a second region having a same setting as the first region set is generated. On image data generated by a reading device from a printed material with image formed, data is extracted from a region corresponding to the first region and from a region corresponding to the second region, and it is checked whether the data extracted from the region corresponding to the first region matches the data extracted from the region corresponding to the second region.

### BACKGROUND

### Field of the Disclosure

The present disclosure relates to an inspection device, a control method for the inspection device, and an inspection system.

### Description of the Related Art

Hitherto, inspections to check whether printed materials are printed correctly have been conducted manually, but in recent years, devices that automatically conduct inspections as post-processing of the printing machine have been used. In this type of inspection device, inspections are conducted on variable region portions (variable data) such as character strings and barcodes in variable printing. For example, data readability inspections check whether character strings and barcodes are readable, while data cross-check inspections compare the reading results of character strings and barcodes against the correct data. Hereinafter, data readability inspections and data cross-check inspections are referred to as data inspections. Additionally, matching inspections are one type of the data inspections.

Japanese Patent Laid-Open No. 2022-69482 proposes techniques for front-and-back matching inspections to check whether the reading results of data inspection regions set on the front side and the back side match.

### SUMMARY

The present disclosure provides an inspection device including: a registration unit configured to register a received image as a reference image; a region setting unit configured to set a first region for conducting a matching inspection on the reference image registered in the registration unit; a generation unit configured to, upon receiving an instruction for a matching inspection, generate a second region having a same setting as the first region set by the region setting unit; an extraction unit configured to extract data from the first region and the second region on a read image obtained by reading, by a reading unit, a printed material with image formed by an image forming unit; and an inspection unit configured to check whether the data extracted by the extraction unit from the first region matches the data extracted by the extraction unit from the second region.

Further features of the present disclosure will become apparent from the following description of exemplary embodiments with reference to the attached drawings.

### BRIEF DESCRIPTION OF THE DRAWINGS

FIG. 1 is an example of a diagram illustrating an example of a system configuration including an inspection device according to one or more aspects of the present disclosure.

FIG. 2 is an example of an internal configuration diagram of an image forming device according to one or more aspects of the present disclosure.

FIG. 3 is an example of an internal configuration diagram of the inspection device according to one or more aspects of the present disclosure.

FIG. 4 is an example of a flowchart of an overall inspection process according to one or more aspects of the present disclosure.

FIG. 5 illustrates an example of a user interface (UI) screen for job management according to one or more aspects of the present disclosure.

FIGS. 6A and 6B illustrate examples of a UI screen for configuring inspection settings according to one or more aspects of the present disclosure.

FIG. 7 is an example of a flowchart of configuring inspection settings (S403) according to one or more aspects of the present disclosure.

FIGS. 8A to 8D illustrate examples of displaying a matching inspection region according to one or more aspects of the present disclosure.

FIG. 9 is an example of a flowchart of generating a matching inspection region (S705) according to one or more aspects of the present disclosure.

FIGS. 10A to 10C illustrate examples of setting a matching inspection region according to one or more aspects of the present disclosure.

FIG. 11 is an example of a flowchart of generating a matching inspection region (S705) according to one or more aspects of the present disclosure.

FIG. 12 illustrates an example of a UI for generating a matching inspection region (S705) according to one or more aspects of the present disclosure.

FIGS. 13A and 13B illustrate examples of a UI for generating a matching inspection region (S705) according to one or more aspects of the present disclosure.

### DESCRIPTION OF THE EMBODIMENTS

Embodiments of the present disclosure will be described in detail with reference to the accompanying drawings. Note that the following embodiments are not construed to restrict the disclosure according to the claims, and not all of the combinations of features described in the embodiments are essential to the solution of the present disclosure.

In the following description, an image forming device may also be referred to as a multi-function peripheral (MFP).

### First Embodiment

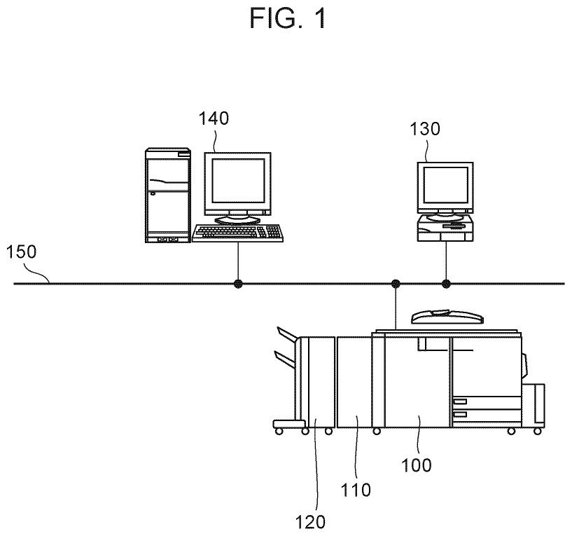

FIG. 1 is a diagram illustrating a system configuration including an inspection device according to an embodiment of the present disclosure.

Reference numeral 100 represents an image forming device, reference numeral 110 represents an inspection device, reference numeral 120 represents a finisher, reference numeral 130 represents a client personal computer (PC), reference numeral 140 represents a print server, and reference numeral 150 represents a network.

The image forming device 100 performs print output based on various types of input data, such as print data sent from the client PC 130 and the print server 140. Although the present embodiment will be described using an image forming device, this is not the only possible type of device, and any device that prints on a recording medium may be suitable. For example, a device that performs printing on metal may be used.

The inspection device 110 inspects printed materials sequentially conveyed from the image forming device 100 to check whether there are any defects. Here, defects refer to those that diminish the quality of the printed material, such as dirt caused by color materials adhering to unintended areas during printing, or color fading resulting from inadequate adhesion of color materials to intended areas.

Furthermore, in variable printing including variable region portions, such as one-dimensional codes including character strings and barcodes and two-dimensional codes including QR codes (registered trademark), the inspection device 110 conducts inspections on the variable region portions. For example, data readability inspections check whether character strings and barcodes are readable, while data cross-check inspections compare the reading results of character strings and barcodes against the correct data. Additionally, front-and-back matching inspections check whether the reading results of data inspection regions set on the front side and the back side match. In other words, the inspection device 110 conducts data inspections, including print image inspections to detect abnormalities in pattern portions of the printed material, as well as data readability inspections and data cross-check inspections. Note that the inspection device 110 need not be equipped internally with an inspection processing unit configured to conduct print image inspections and data inspections; rather, the inspection device 110 may be configured to conduct inspection processes using an information processing device (not illustrated) as an inspection PC that is communicatively connected to the inspection device 110. Note that, in the present embodiment, barcode inspections refer to inspections capable of inspecting not only one-dimensional codes but also two-dimensional codes such as QR codes. In addition, the inspection system according to the present embodiment is assumed to be configured of at least the inspection device 110 configured to inspect printed materials.

The finisher 120 receives the output sheets inspected by the inspection device 110, switches the paper ejection destination based on the inspection results of the inspection device 110, performs post-processing (such as booklet binding and stapling) as necessary, and then ejects the sheets.

The image forming device 100 is connected to the client PC 130 and the print server 140 via the network 150, and is further connected to the inspection device 110 and the finisher 120 via communication cables. The inspection device 110 is also connected to the finisher 120 via a communication cable, in addition to the image forming device 100. The present embodiment will be described using, as an example, an in-line inspection machine that coherently performs image formation, inspection, post-processing, and discharge, but this is not construed to restrict the present disclosure.

### Configuration Diagram of Image Forming Device

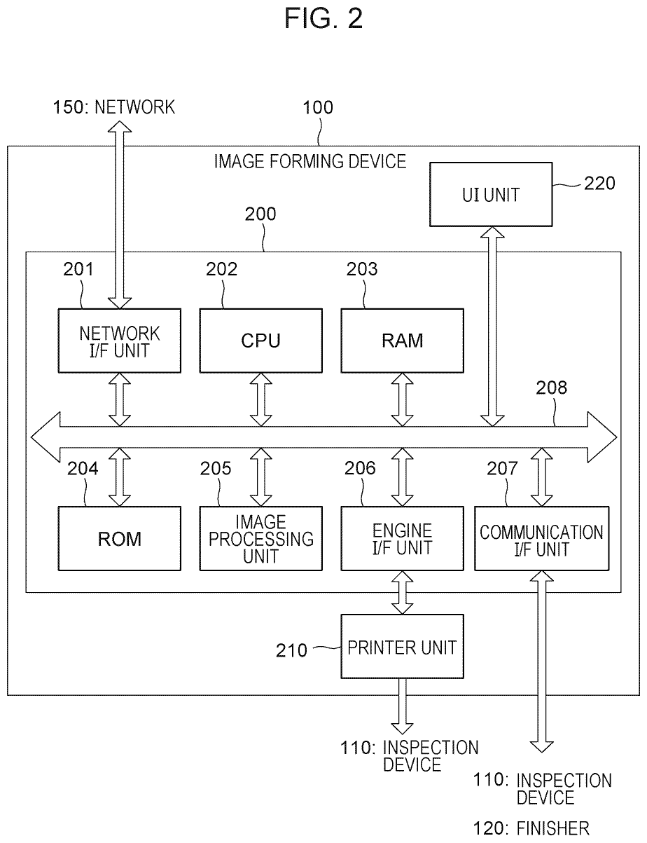

FIG. 2 is a diagram illustrating the internal configuration of the image forming device 100 according to the present embodiment. A controller 200 receives images and documents from the network 150 and converts the received images and documents into print data. A printer unit 210 generates printed materials in which the print data is printed on recording sheets (paper sheets). A UI unit 220 displays screens and accepts instructions for the image forming device 100 from an operator, such as selecting paper information. The image forming device 100 includes the controller 200, the printer unit 210, and the UI unit 220 described above.

Reference numerals 201 to 208 represent components of the controller 200. The network interface (I/F) unit 201 sends and receives data to and from the client PC 130 and the print server 140 via the network 150. The CPU 202 comprehensively controls the image forming device 100.

The RAM 203 is a work area for the CPU 202 to execute various commands, and the ROM 204 stores program data executed by the CPU 202 upon activation, configuration data for the controller 200, and the like. The image processing unit 205 performs raster image processor (RIP) processing for converting images and document data received from the network 150 into print data.

Note that, in the present embodiment, RIP processing need not be performed by the image processing unit 205, and, for example, an information processing device (not illustrated) communicatively connected to the image forming device 100 may be configured to perform RIP processing.

The engine interface (I/F) unit 206 sends print data to the printer unit 210. The communication I/F unit 207 communicates with the inspection device 110 and the finisher 120. Reference numeral 208 represents an internal bus (system bus).

Images and documents created on the client PC 130 and the print server 140 on the network 150 are sent to the image forming device 100 via a network (such as a local area network (LAN)) as page description language (PDL) data. It may be configured that print jobs such as images and documents are sent to an information processing device (not illustrated) via a network and managed by the information processing device. Then, it may be configured that the print jobs are sent from the information processing device to the image forming device 100 through the network 150, and the image forming device 100 performs printing on paper.

The sent PDL data is saved in the RAM 203 via the network I/F unit 201. Print instructions given by the operator of the UI unit 220 are also saved in the RAM 203 through the internal bus 208. An example of a print instruction given by the operator is selecting the paper type.

The image processing unit 205 obtains the PDL data saved in the RAM 203 and performs image processing to convert it into print data. Image processing to convert the PDL data into print data involves, for example, rasterizing the PDL data to convert it into multivalued bitmap data, and then performing screening processing or the like to convert the multivalued bitmap data into binary bitmap data. The binary bitmap data obtained by the image processing unit 205 is sent to the printer unit 210 via the engine I/F unit 206.

The printer unit 210 prints the received binary bitmap data onto recording sheets using color materials. The CPU 202 issues instructions to the printer unit 210 based on the print instructions given by the operator saved in the RAM 203. For example, if there is an instruction from the operator to print on coated paper, the CPU 202 instructs the printer unit 210 to output paper from a paper cassette (not illustrated) containing coated paper within the image forming device 100. Various processes from receiving the above-mentioned PDL data to printing on the paper are controlled by the CPU 202, resulting in the formation of a full-color toner image on the paper.

### Internal Configuration of Inspection Device 110

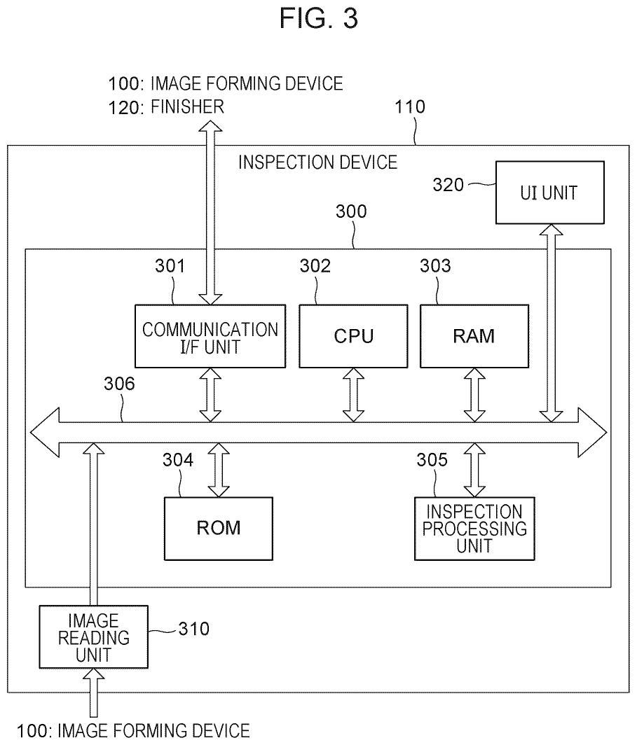

FIG. 3 is a diagram illustrating the internal configuration of the inspection device 110. An inspection control unit 300 comprehensively controls the inspection device 110 and controls the inspection process to determine whether there are defects in the printed material.

An image reading unit 310 reads the printed material conveyed from the image forming device 100.

The image reading unit 310 generates a scanned image (read sheet) by reading the printed material.

A UI unit 320 is a UI unit for the operator to configure the inspection device 110 and for displaying the inspection results to the operator. Note that the configuration of the inspection device 110 performed by the operator here refers to the items determining what defects to inspect for when inspecting the printed material. The inspection items include, for example, circular defects (dots) as well as linear defects (streaks). The inspection device 110 includes the inspection control unit 300, the image reading unit 310, and the UI unit 320 described above. In the present embodiment, the UI unit 320 includes a display configured to display a screen and a display control unit configured to control the screen displayed on the display. Additionally, it may be configured that the configuration of the inspection device 110 and the display of inspection results performed by the UI unit 320 are performed by an external device, such as the UI unit 220 of the above-mentioned image forming device 100, an inspection PC (not illustrated), or an information processing device (not illustrated), which performs the display and accepts instructions.

Reference numerals 301 to 306 represent components of the inspection control unit 300. The communication interface (I/F) unit 301 sends and receives data to and from the image forming device 100, the finisher 120, and an inserter. The CPU 302 comprehensively controls the inspection device 110. The RAM 303 is a work area for the CPU 302 to execute various commands, and the ROM 304 stores program data executed by the CPU 302 upon activation, configuration data for the inspection control unit 300, and the like. Additionally, the correct comma-separated values (CSV) file, which will be described later, is stored in the ROM 304. The inspection processing unit 305 inspects the printed material to determine whether there are any defects. The internal bus 306 is a system bus.

### Print Image Inspection

An overview of a print image inspection conducted by the inspection device 110 will be described. The inspection device 110 reads, with the use of the image reading unit 310, the printed material conveyed from the image forming device 100, and obtains a scanned image (read image) of the inspection target. The obtained scanned image of the inspection target is saved in the RAM 303. Then, the inspection device 110 obtains, with the use of the inspection processing unit 305, difference values between a reference image which is saved in advance in the RAM 303 as the correct image and the scanned image of the inspection target.

Next, the inspection device 110 conducts an inspection by comparing the calculated difference values with inspection thresholds for the inspection items (such as contrast and size) on a pixel by pixel basis. The results of the inspection are saved in the RAM 303; for example, information on whether there are any abnormalities in the printed material, the types of abnormalities detected (dots and streaks), the position information of the abnormalities to be displayed on the UI unit 320, and the like are saved.

### Data Inspection

An overview of a data inspection conducted by the inspection device 110 will be described. The inspection device 110 reads, with the use of the image reading unit 310, the printed material sequentially conveyed from the image forming device 100, and obtains a scanned image of the inspection target. The obtained scanned image of the inspection target is saved in the RAM 303. Then, the inspection processing unit 305 of the inspection device 110 first performs an extraction process to extract data from character strings and barcodes/QR codes within the scanned image. This is implemented using preset glyph fonts for character recognition (optical character recognition (OCR)) and barcode standards, and OCR processing is performed for characters. Decoding processing is performed for barcodes. A data inspection checks whether character strings and barcodes within a region configured to conduct a data inspection are readable. If they are readable, an “OK” judgment is made, whereas if they are unreadable, a “no good (NG)” judgment is made. Additionally, a data cross-check inspection can also be conducted, which compares the reading results of character strings and barcodes, which are the extracted data, against the corresponding data (correct data) in the prepared correct CSV file. Here as well, if the items of data match as a result of the comparison, an “OK” judgment is made, whereas if the items of data do not match, an “NG” judgment is made. The results of the inspections are saved in the RAM 303; for example, the results of reading character strings and barcodes from the printed material, the results of comparison with the correct data, the position information of the read characters and barcodes to be displayed on the UI unit 320, and the like are saved.

### Front-and-Back Matching Inspection

An overview of a front-and-back matching inspection conducted by the inspection device 110 will be described. As with a data inspection, the inspection device 110 performs an extraction process to read the printed material and extract data from character strings and barcodes/QR codes within the scanned image that has been read. A front-and- back matching inspection determines whether the data extracted from the front side matches the data extracted from the back side. If they match, an “OK” judgment is made, whereas if they do not match, an “NG” judgment is made. The results of the inspection are saved in the RAM 303; for example, the results of reading character strings and barcodes from the printed material, the results of whether the front and back sides match, the position information of the characters and barcodes to be displayed on the UI unit 320, and the like are saved.

After completing the print image inspection, data inspection, and front-and-back matching inspection described above, the inspection device 110 instructs, with the use of the CPU 302, the UI unit 320 to display the inspection results saved in the RAM 303. By displaying the inspection results on the UI unit 320, the operator recognizes the inspection results. In addition, when a defective printed material occurs or such defective printed material occur continuously in a certain quantity, the inspection device 110 sends, with the use of the CPU 302, the above information to the image forming device 100 via the communication I/F unit 301.

Information regarding the occurrence of defective printed materials is received by the controller 200 via the communication I/F unit 207. When the controller 200 receives the above information, the CPU 202 instructs the printer unit 210 to stop printing. The image forming device 100 stops the printing operation when the printer unit 210 is instructed to stop printing.

Furthermore, the inspection device 110 also sends, with the use of the CPU 302, information to the finisher 120 via the communication I/F unit 301 based on the inspection results saved in the RAM 303. The information sent to the finisher 120 is information regarding whether there are defects in the printed material. Using the received information, the finisher 120 ejects printed materials without defects to the regular output tray and ejects printed materials with defects to a separate tray from the regular output tray.

### Overall Flow of Inspection

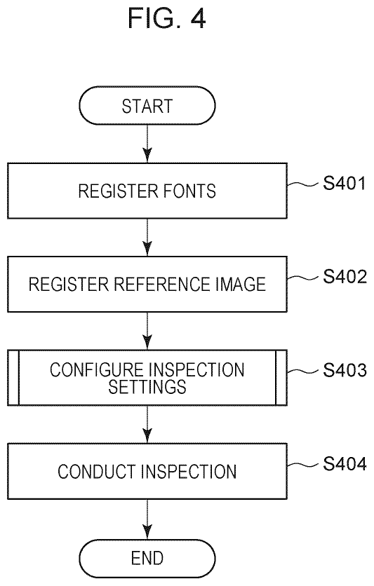

Next, the overall flow from registration before starting the inspection in the inspection device 110 to the execution of the inspection will be described using the flowchart illustrated in FIG. 4. This flowchart is realized by the CPU 302 deploying program code stored in the ROM 304 to the RAM 303, and reading and executing the program code deployed in the RAM 303.

In step S401, the CPU 302 registers glyph fonts. The glyph fonts registered here are used during data inspections. A glyph font refers to data that associates character shape images with character codes, which is necessary for character recognition (OCR) during data inspections. In the procedure for creating a glyph font, first the inspection device 110 waits in the glyph font image loading mode, and receives a print job for glyph font creation from the client PC 130. The inspection device 110 receives a glyph font job from the client PC 130 and loads a glyph font image. When printing is performed, the inspection device 110 detects the conveyance of a printed material from the image forming device 100, scans the printed material with the image reading unit 310, and saves the scanned image in the RAM 303 of the inspection device 110. A glyph font can be created by extracting, one character at a time, the characters to be subjected to OCR from the scanned image, and the operator enters character codes for the extracted character images. The created glyph font is saved in the RAM 303 of the inspection device 110. While the method of creating glyph fonts according to the present embodiment has been described here, this is not the only method available. Any method capable of creating data that associates character codes with character images extracted from the scanned image may be used. Additionally, it is possible to conduct only print image inspections without performing data inspections. In this case, the process transitions to S402 without performing S401.

In step S402, the CPU 302 registers a reference image that will be the correct image for the inspection. The inspection device 110 waits in the reference image loading mode, and executes a print job for reference image registration from the client PC 130. When printing is performed, the inspection device 110 detects the conveyance of a printed material, scans the printed material using the image reading unit 310, and saves the scanned image as a reference image in the RAM 303 of the inspection device 110. In the present embodiment, registration is performed by scanning a reference image using the image reading unit 310, but this is not the only method available. For example, a method of registering an image that has been RIP-processed by the print server 140 or the image processing unit 205 of the image forming device 100 as a reference image may be used.

In step S403, the CPU 302 accepts inspection settings and saves various inspection setting values such as an inspection region, inspection level, etc. in the RAM 303 of the inspection device 110. Note that the details of S403 in the present embodiment will be described later.

In step S404, the CPU 302 receives a print job for inspection from the client PC 130, detects the conveyance of paper, scans the paper using the image reading unit 310, and saves the scanned image in the RAM 303 of the inspection device 110. Then, the inspection device 110 conducts a pattern inspection on the scanned image of the inspection job and the reference image registered in S402 using the inspection settings configured in S403. Additionally, the inspection device 110 conducts a data inspection using the glyph fonts registered in step S401 and the inspection settings configured in step S403. The process of this flowchart ends.

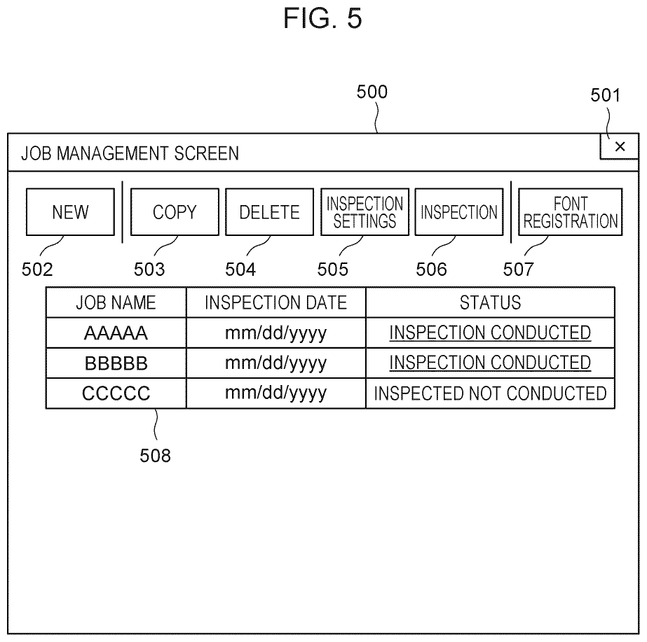

FIG. 5 illustrates an example of a job management screen 500 displayed on the UI unit 320.

The job management screen 500 is displayed when the inspection device 110 is activated. Alternatively, the job management screen 500 is displayed when an application is activated by an operator's operation performed on the UI unit 320.

It is possible to transition from the job management screen 500 to each of the following steps: font registration, reference image registration, configuration of inspection settings, and inspection.

A button 501 is a button for turning off the display of the screen 500. A button 502 is a button for creating a new inspection job, where a reference image is registered.

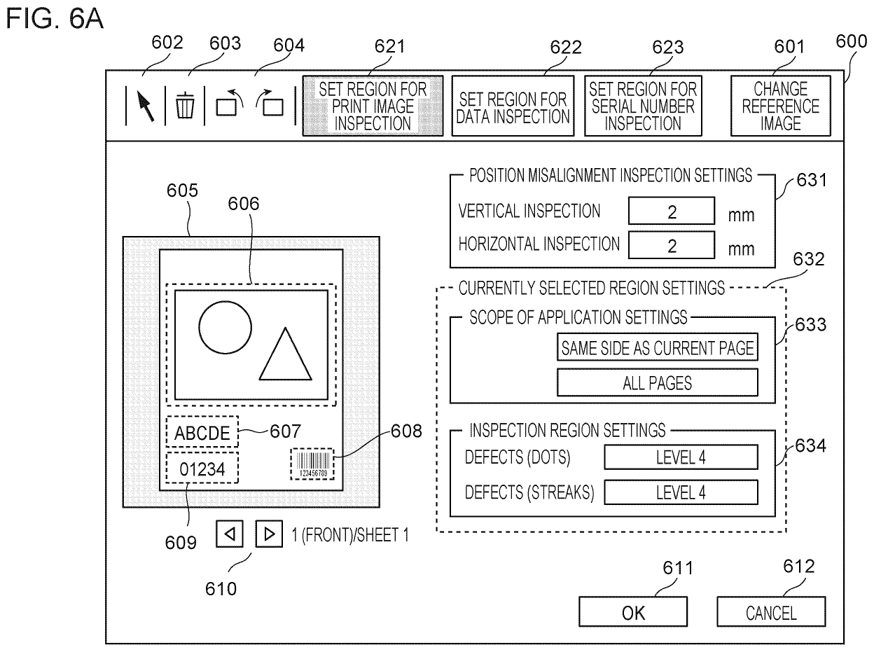

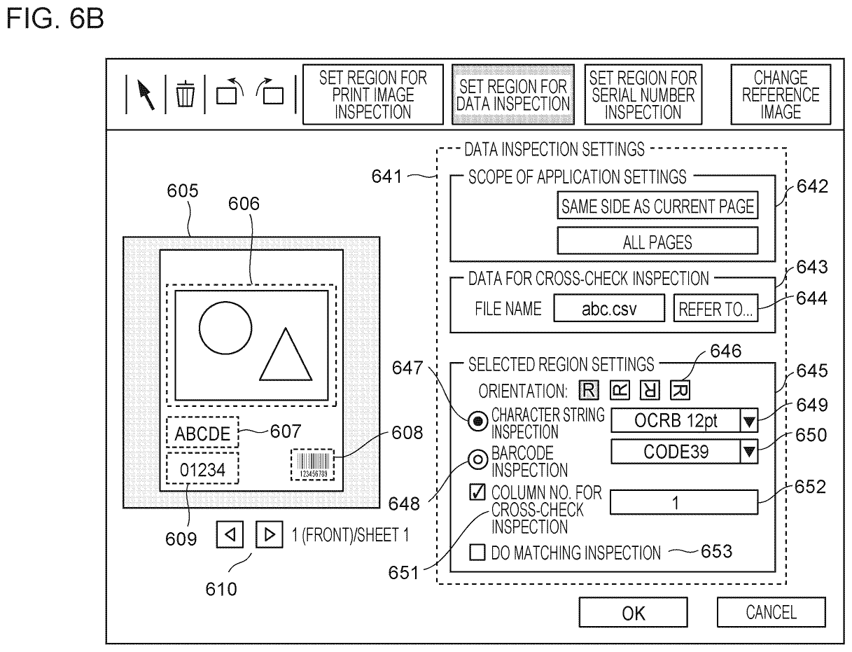

A button 503 is a button for copying an already created inspection job. An inspection job selected from an inspection job list 508 is copied. Through copying, it is possible to copy a reference image and inspection settings, enabling a new inspection to be conducted. Pressing the button 503 will transition to an inspection settings screen illustrated in FIGS. 6A and 6B.

A button 504 is a delete button for deleting an inspection job selected from the inspection job list 508. Here, it is also possible to simultaneously delete multiple inspection jobs by selecting these inspection jobs and pressing the button 504. A button 505 is an inspection settings button for configuring the inspection settings of an inspection job for which reference image registration has been completed.

A button 506 is an inspection button for conducting an inspection of an inspection job for which reference image registration and the configuration of inspection settings have been completed. A button 507 is a font registration button for registering glyph fonts.

### Configuration of Inspection Settings

Next, configuration of inspection settings will be described using FIGS. 6A and 6B. FIG. 6A illustrates an example of an inspection settings screen 600 displayed on the UI unit 320 of the inspection device 110 for configuring inspection settings.

A button 601 is a reference image change button used when changing a reference image. A button 602 is an inspection region selection button pressed by an operator when the operator wishes to select an already set region.

A button 603 is an inspection region delete button 603 pressed by an operator when the operator wishes to delete a selected region. Buttons 604 are buttons for rotating an image displayed in a region 605.

The region 605 is a display region that displays a loaded reference image. If there are multiple sheets to be loaded, buttons 610 are used to switch the image being displayed. The buttons 610 are also used to switch the front/back of the loaded sheet. Specifically, each time the right-arrow button 610 is pressed, the image being displayed switches sequentially as follows: the front side of the first sheet, the back side of the first sheet, the front side of the second sheet, and the back side of the second sheet.

A button 611 is an OK button for saving the settings on the screen 600 and transitioning to the job management screen 500 illustrated in FIG. 5. Additionally, pressing the button 611 will alternatively transition to an inspection screen (not illustrated), allowing an inspection to be executed. A button 612 is a cancel button for transitioning to the job management screen 500 illustrated in FIG. 5 without saving the settings on the screen 600.

A button 621 is a button that is pressed by the operator when creating a new region for print image inspection. After pressing the button 621, the operator sets an inspection region on the reference image displayed in the region 605. A region 606 depicts an example in which a print image inspection region is set.

A button 622 is a button that is pressed by the operator when creating a new region for character inspection or barcode inspection. After pressing the button 622, the operator sets an inspection region on the reference image displayed in the region 605. A region 607 depicts an example in which a character inspection region is set. A region 608 depicts an example in which a barcode inspection region is set. Note that, in FIGS. 6A and 6B, the region 606, the character region 607, and the region 608 are depicted with the same black dotted lines, but it may be acceptable to display them distinctly that allows for easy differentiation, indicating that they are regions where different processing is performed. For example, the frames of the regions where different processing is performed may be displayed using different colors or dashed lines. It is also acceptable to allow the display colors of the frames to be selectable by the operator.

A button 623 is a button that is pressed by the operator when creating a new region for serial number inspection. After pressing the button 623, the operator sets an inspection region on the reference image displayed in the region 605. A serial number inspection involves a data inspection conducted based on certain rules. The certain rules include the start number, end number, increment/decrement value, and the like.

A setting item 631 is a setting for position misalignment inspection, allowing the operator to set the permissible deviation amount for the printed position from the reference image. The present embodiment illustrates an example where the operator specifies the detection of position misalignment greater than or equal to 2 mm. In other words, the value specified by the operator here corresponds to the threshold for the detection of position misalignment. If a misalignment greater than or equal to the threshold set here is detected, the inspection is determined as “NG”.

A setting region 632 contains a group of UIs for configuring settings for the currently selected region in the region 605. A setting item 633 is used to set the range of application for the selected region. If nothing is selected, the currently selected inspection region is placed only on the page currently displayed in the region 605. If “Same side as current page” is selected, the currently selected inspection region is placed on the page of the same side, depending on whether the currently selected inspection region is located on the front side or the back side of the sheet. If “All Pages” is selected, the currently selected inspection region is placed on all pages.

A setting item 634 includes settings for circular defects (dots) and linear defects (streaks), allowing the operator to set the respective detection levels. The detection levels refer to parameters set in stages to determine, for each characteristic of detected defects, at what size they are determined as defects. For example, there are five levels ranging from level 1 to level 5, and level 5 can detect thinner and smaller defects compared to level 1. Additionally, it is possible to set the level for each inspection item, such as level 5 for dots and level 4 for streaks. In the setting item 634, it is depicted that the operator has selected level 4 for the inspection level setting for defects (dots), and also has selected level 4 for the inspection level setting for defects (streaks).

FIG. 6B illustrates an example of an inspection settings screen in the case where the currently selected setting region is a data region.

A setting region 641 contains a group of UIs for configuring settings for a data inspection region displayed in the case where the data inspection region is selected in the region 605.

Here, it will be described that the currently selected region is the character region 607, but the same settings are configured for a character region 609. It is assumed that, in the region 605, a selected region and an unselected region are displayed distinctly, allowing for easy differentiation.

A setting region 642 is used to set the range of application for the selected region. If nothing is selected, the currently selected inspection region is placed only on the page currently displayed in the region 605. If “Same side as current page” is selected, the currently selected inspection region is placed on the page of the same side, depending on whether the currently selected inspection region is located on the front side or the back side of the sheet. If “All Pages” is selected, the currently selected inspection region is placed on all pages.

A setting region 643 is a region for setting the correct CSV file to be used for a cross-check during a cross-check inspection. Pressing a button 644 will select a file, allowing the selected file name to be displayed. The specification of the correct CSV file is common for both character inspections and barcode inspections. A setting region 645 is used to set the currently selected data inspection region. Here, the orientation, selection of inspection regions for characters and barcodes, font type, barcode type, whether to perform cross-check inspection, and specification of columns in the correct CSV file during cross-check inspection are specified. These settings required for data inspections are referred to as inspection parameters.

Setting items 646 are used to set the orientation of the characters in the character region 607. A setting item 647 and a setting item 648 are used to specify whether the selected region is for character string inspection or barcode inspection. A setting item 649 is used to set a font for performing OCR processing in the character region 607. A setting item 650 is used to set a barcode type when barcode inspection is selected in the setting item 648.

A setting item 651 is used to set whether to conduct cross-check inspection. If cross-check inspection is set to “enabled,” OCR processing is performed on the character region 607 using the correct CSV file specified in the setting region 643 and the column number specified in a setting item 652. Then, a cross-check inspection is conducted by comparing the read character string with the character string specified in the correct CSV file.

A setting item 653 is used to set whether to conduct matching inspection. A matching inspection refers to checking whether the results of reading two or more inspection regions match. For example, a matching inspection region (not illustrated) for conducting a matching inspection is set on the opposite side of the currently selected character region 607, and it is determined whether the results of reading the regions on the front and back sides match. In particular, conducting a matching inspection between an object on the front side and an object on the back side may be referred to as a front-and-back inspection or a front-and-back matching inspection.

Here, examples of data inspections include data readability inspections to check whether character strings and barcodes are readable, data cross-check inspections to compare the reading results of character strings and barcodes against the correct data, and front-and-back matching inspections to check whether the reading results of the front side and the back side match. However, these are not the only types of inspections available. For example, it is acceptable to conduct sequential number inspections to check whether the reading results are in sequence, or matching inspections to verify whether multiple reading results within the plane match. Any data inspection may be conducted as long as it reads character strings and barcodes and inspects the reading results.

### Inspection Setting Configuration Flow

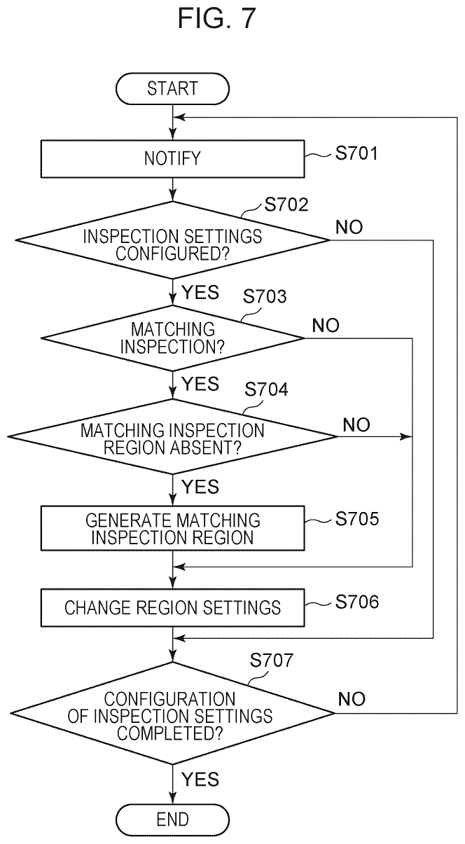

Next, the flow of configuring inspection settings in S403 will be described using the flowchart illustrated in FIG. 7.

This flowchart is realized by the CPU 302 of the inspection device 110 deploying program code stored in the ROM 304 to the RAM 303, and reading and executing the program code deployed in the RAM 303.

In step S701, the CPU 302 receives a notification of the operator's UI operation from the UI unit 320.

In step S702, the CPU 302 determines whether inspection settings have been configured. Specifically, it is determined whether a new data inspection region has been created or whether the settings for an already created data inspection region have been changed. In the case where inspection settings have been configured (YES in step S702), the flow proceeds to step S703. In the case of operations other than the configuration of inspection settings (NO in step S702), the flow proceeds to step S707.

In step S703, the CPU 302 determines whether a matching inspection has been set in the configuration of inspection settings in step S702. In the case where a matching inspection has been set (YES in step S703), the flow proceeds to step S704. In the case where a matching inspection has not been set (NO in step S703), the flow proceeds to step S706.

In step S704, the CPU 302 determines whether a matching inspection region has already been generated. A matching inspection region refers to a region for conducting a matching inspection with the data inspection region set in step S702. In the case where a new data inspection region is created, a matching inspection region has not yet been generated (YES in step S704), so the flow proceeds to step S705. If there has been a change in the settings of the data inspection region, a matching inspection region has already been generated (NO in step S704), so the flow proceeds to step S706.

In step S705, the CPU 302 generates a matching inspection region for the data inspection region set in step S702. For a matching inspection region generated here, the same inspection settings as the inspection settings configured for the selected inspection region, such as orientation and font type, are configured. A matching inspection region generated here may be generated within the same page as the sheet where the data inspection region has been set in S702, or may be generated on a different page. Alternatively, a matching inspection region may be generated on a different page of the same sheet.

In step S706, the CPU 302 accepts changes to the settings for the inspection region from the operator. When changing the settings for the matching inspection region, there may be restrictions on the items that can be changed, or confirmation may be required when making changes; further details will be provided later.

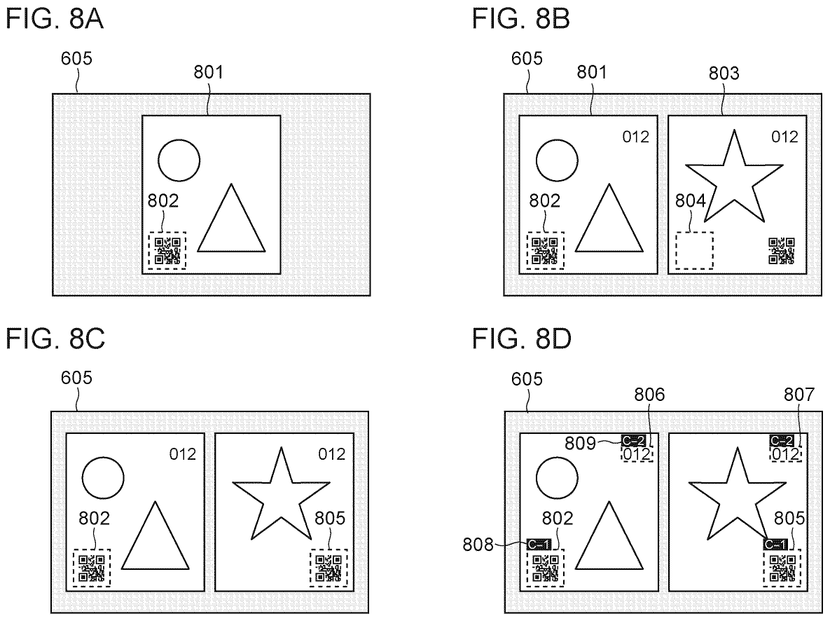

Generation of a matching inspection region will be specifically described using FIGS. 8A to 8D. FIG. 8A illustrates the region 605 when the data inspection region is set in step S702. An image 801 is a reference image, and a QR code within the image is set as a data inspection region 802.

Being set refers to a state in which all items required to be set for the setting region 641 illustrated in FIG. 6B have been set. The required items include, for example, in the case of data readability inspection, orientation, selection of inspection regions for characters and barcodes, font type, and barcode type. In the case of data cross-check inspection, the required items include selection of inspection regions for characters and barcodes, font type, barcode type, whether to perform cross-check inspection, and columns in the correct CSV file during cross-check inspection. In the case of enabling matching inspection for the data inspection region 802, it is desirable that it is after the required items for settings mentioned above have been set. This is because it takes over the settings for the data inspection region when automatically generating a matching inspection region, thereby realizing the reduction of the operator's workload in configuring the settings. Therefore, the matching inspection setting item 653 is grayed out until the required items are set for the data inspection region 802. Alternatively, an alarm may be issued when the matching inspection setting item 653 is enabled in a state where the required items have not been set.

FIG. 8B illustrates the region 605 when the matching inspection region is set in step S705. An image 803 displayed side by side with the image 801 is a back side image of the image 801, and has the same QR code as the image 801. When the data inspection region 802 is selected and a matching inspection is set, the CPU 302 generates and displays a matching inspection region 804. At this time, the selected region transitions from the data inspection region 802 to the matching inspection region 804. The settings for the matching inspection region 804 are all identical to the data inspection region 802 except that it is placed on the back side of the data inspection region 802. Therefore, at the time of generating the matching inspection region 804, the matching inspection region 804 is not aligned with the position of the QR code in the image 803. Here, the operator changes the settings of the matching inspection region 804.

In the present embodiment, the front side image and the back side image may be displayed side by side in the region 605, as illustrated in FIG. 8B. The display in which the front side and the back side are arranged side by side may be switched by pressing a button (not illustrated) for switching the display method, or may be configured to be switched by pressing the matching inspection setting item 653.

FIG. 8C illustrates a matching inspection region 805 with a setting change completed. The setting change here is a change in the position of the matching inspection region 804. Methods for changing the position may include the operator's dragging and dropping the matching inspection region 804, or the operator's selecting the position of the QR code again. Any method that can appropriately change the inspection region is suitable. Other setting items related to data inspections are also changeable by the operator as needed. However, if a data cross-check inspection is set for the data inspection region 802, the correct CSV file in the setting region 643, whether to conduct cross-check inspection in the setting item 651, and a change in the setting of the column number in the setting item 652 may not be accepted. Methods for prohibiting changes to the settings may include graying out items that do not accept changes, or issuing a warning when a setting is changed. Any method that can notify the operator that the setting is unchangeable is suitable.

After completing the settings for the matching inspection region once, if the operator wishes to change the inspection settings, the CPU 302 displays the front side image and the back side image side by side, as illustrated in FIG. 8C, to allow for changes to the inspection settings. If the settings for the data inspection region 802 are changed, whether to apply these setting changes to the matching inspection region 805 is checked via a pop-up on the UI each time the setting is changed, or is predetermined in the default settings. Additionally, in FIGS. 8B and 8C, the data inspection region 802 and the matching inspection regions 804 and 805 are depicted with the same black dashed lines. Alternatively, this may be changed to, for example, displaying the automatically-generated matching inspection regions 804 and 805 with different line colors, shapes, thicknesses, actions, etc., compared to the data inspection region 802, and, after the configuration of the settings is completed, the matching inspection regions 804 and 805 may be displayed in the same manner as the data inspection region 802. Note that, if the operator wishes to conduct matching inspections at two positions, i.e., a character string and a QR code as illustrated in FIG. 8D, for example, a matching inspection is specified after specifying the data inspection region 802, and the data inspection region 805 is generated. Furthermore, a matching inspection is specified after specifying a data inspection region 806, and a data inspection region 807 is generated. In doing so, two locations on one sheet can be specified for matching inspections.

Next, in step S707, the CPU 302 determines whether the configuration of the settings is completed for the inspection region.

Here, it is determined whether the button (OK button) 611 illustrated in FIG. 6A has been pressed. In the case where the button 611 has been pressed (YES in step S707), the CPU 302 determines that the configuration of the inspection settings is completed, saves the setting values configured on the inspection settings screen in the RAM 303, and ends the process of configuring the inspection settings. In the case where the OK button has not been pressed (NO in step S707), the flow returns to step S701, where the CPU 302 waits for a notification of the UI operation. So far, the flow of configuring inspection settings in step S403 has been described.

### Matching Inspection

The flow of configuring matching inspection settings has been described so far; now, the inspection content and display method for matching inspections will be described.

As mentioned earlier, matching inspections are one type of data inspections, which check whether two items of data match. Therefore, the display format of the data need not be identical; the data items may consist of both character strings, a combination of a character string and a barcode, etc. The data items may be presented in any format as long as the final reading results match.

Multiple methods are conceivable for matching inspections. Here, in the case where a matching inspection is set for each of data A and data B in certain print data, an inspection is conducted by an inspection method described below for each of data A and data B. First, the case will be described in which it is checked whether the reading results of regions set to conduct a matching inspection match. The CPU 302 sequentially saves the reading results of all regions set to conduct a matching inspection in the RAM 303, and compares the saved reading results to determine the data that matches and the data that does not match. If there is even one item of data that does not match, the matching inspection is “NG”.

Next, the case will be described in which all matching inspection regions are checked against the same CSV data as the correct data. The CPU 302 sequentially saves the data cross-check inspection results of all regions set to conduct a matching inspection in the RAM 303, and determines whether there is data determined as “NG”. If there is even one item of “NG” data, the matching inspection is “NG”.

Furthermore, the case will be described in which a data cross-check inspection is conducted in only one matching inspection region, and the other matching inspection regions are checked to see if they match the reading result of the inspection region where the data cross-check inspection has been conducted. The CPU 302 saves the data cross-check inspection result as well as the reading results of all matching inspection regions, and compare the saved reading results to determine the data that matches and the data that does not match. If the data cross-check inspection is “NG” or if there is even one item of data that does not match, the matching inspection is “NG”.

An example of the method of displaying matching inspection regions will be described using FIG. 8D. FIG. 8D illustrates an example where matching inspections for data A and data B are set, that is, matching inspections for two items of data are set on the front and back sides of a printed material.

Characters in data inspection region 806 and characters in the data inspection region 807 are targets of a matching inspection different from data A displayed as QR codes in the inspection regions 802 and 805 mentioned earlier. In addition, an icon 808 and an icon 809 are icons added to the matching inspection regions. Addition of the same icon to the matching inspection regions will facilitate the recognition of regions subjected to a matching inspection. Additionally, if multiple matching inspection regions are set within a page, the distinction of these regions is made by numbering the icons differently. The method of displaying matching inspection regions is not limited to the above, and any method is suitable as long as it allows for the regions subjected to a matching inspection to be easily recognized and distinguished, such as by adding marks, changing the pattern, thickness, and color of the border lines, and so on.

As described above, according to the present embodiment, upon enabling matching inspection, images on the front and back sides are displayed side by side on the settings screen, and, at the same time, a matching inspection region is automatically generated on the back side and displayed, leading to significant reduction of the workload in configuring the settings of a matching inspection region.

### Second Embodiment

In the first embodiment, the method of automatically generating a matching inspection region for a region selected by the operator and applying the final changes to the settings of the automatically-generated region has been described. However, because the generated matching inspection region has the same settings as the data inspection region, the position of the matching inspection region may be misaligned, or the setting of the orientation of the characters may be different. Specifically, even if the regions subjected to a matching inspection within the plane are identical on the front and back sides, the position of the inspection region may be different, depending on the imposition during printing or the direction of binding during double-sided printing. Alternatively, while it may not be possible to locate the inspection region at the exact same position due to the configuration of content within the plane, there are cases where the inspection region is arranged with a certain degree of regularity considering design aesthetics and visibility.

In a second embodiment, a method for improving the accuracy of setting a matching inspection region which is automatically generated considering the above- mentioned regularity, and reducing the manual settings configured by the operator will be described.

Hereinafter, portions of the second embodiment that are different from the first embodiment explained earlier will be described. Note that portions that are not described in detail are the same as those in the first embodiment.

### Flow of Generating Matching Inspection Region

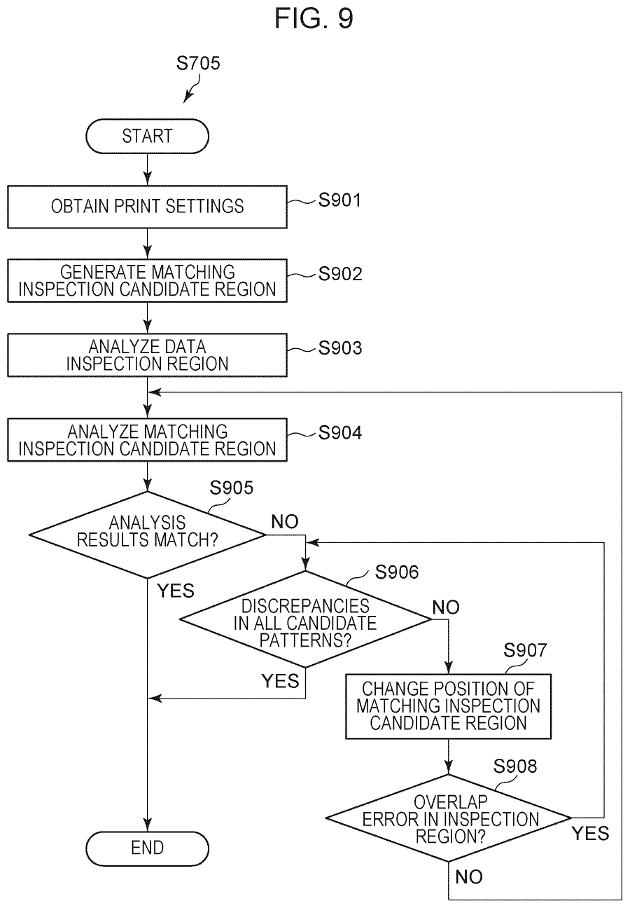

While the flow of configuring inspection settings in step S403 in the present embodiment is as indicated in the flowchart illustrated in FIG. 7, the flow of generating a matching inspection region in step S705, which is a feature of the present embodiment, will now be described using the flowchart illustrated in FIG. 9. This flowchart is realized by the CPU 302 of the inspection device 110 deploying program code stored in the ROM 304 to the RAM 303, and reading and executing the program code deployed in the RAM 303.

In step S901, the CPU 302 receives from the RAM 303 print settings for a print job executed for reference image registration. The print settings are sent from the client PC 130 or the print server 140, where a print job for reference image registration has been executed, to the image forming device 100 via the network 150. The print settings are further sent to the inspection device 110 via the communication I/F unit 301 and saved in the RAM 303. The print settings specifically refer to the settings of image orientation (portrait or landscape), imposition, and binding during double-sided printing.

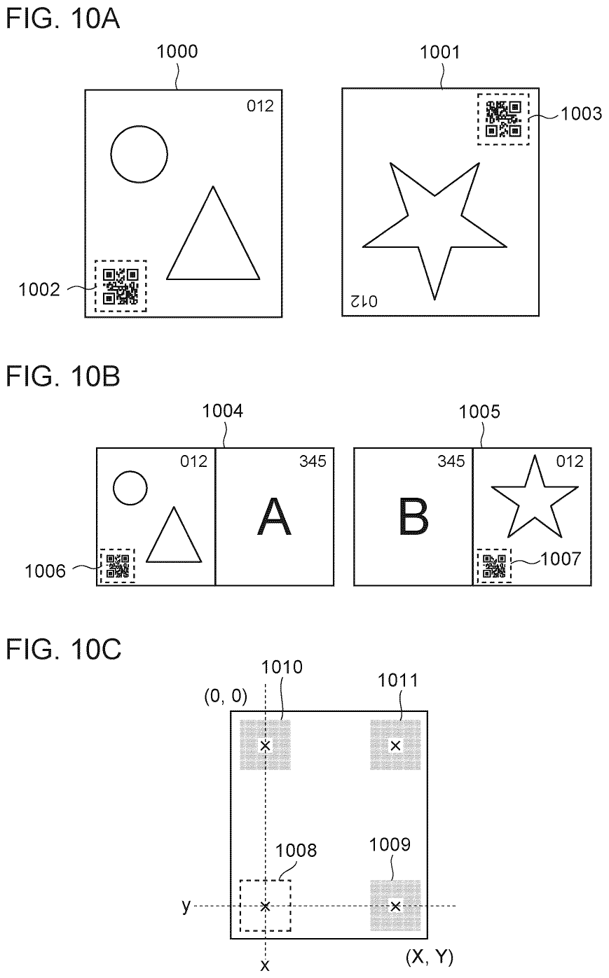

In step S902, the CPU 302 generates a matching inspection candidate region based on the print settings. Some examples of the generation of a matching inspection candidate region will be described using FIGS. 10A to 10C. Here, it is assumed that the subject of the matching inspection is QR codes, and it is assumed that their positions within the plane are the same. An image 1000 and an image 1001 in FIG. 10A depict images on the front and back sides with a portrait orientation, single-page imposition, and binding along the shorter edge. If the print settings received in step S901 are the conditions mentioned above, a matching inspection candidate region for a data inspection region 1002 would be 1003. Because the settings of the matching inspection candidate region 1003 are such that its position is radially symmetrical to the data inspection region 1002, and since the page is upside down, the orientation setting of the matching inspection candidate region 1003 is rotated 180 degrees.

An image 1004 and an image 1005 in FIG. 10B depict images on the front and back sides with a portrait orientation, two-page imposition, and binding along the shorter edge. If the print settings received in step S901 are the conditions mentioned above, a matching inspection candidate region for a data inspection region 1006 would be 1007. The back side for the left page of the image 1004 is the right page of the image 1005. Therefore, the position of the matching inspection candidate region 1007 is set to be moved to the right by half the distance of the long edge of the printing paper from the data inspection region 1006.

As described above, on the assumption that the regions to be matching-inspected are located at the same position within the plane, a matching inspection candidate region is generated by determining the position and orientation estimated based on the print settings. Next, the CPU 302 checks the certainty of the matching inspection candidate region.

In step S903, the CPU 302 analyzes the data inspection region and saves the analysis result in the RAM 303. Here, the term “analysis” may include analysis techniques such as OCR, barcode analysis, analysis of pixel value histograms, etc., which extract features within each region to check the degree of match between regions.

In step S904, the CPU 302 analyzes the matching inspection candidate region and saves the analysis result in the RAM 303.

In step S905, the CPU 302 retrieves the analysis result obtained in step S903 and the analysis result obtained in step S904 from the RAM 303, and compares them. In the case of the OCR results or barcode analysis results, their content is compared to determine whether they match. In the case of feature amounts extracted based on pixel values such as histograms, a threshold (such as 90%) for the degree of match is provided, rather than a perfect match (100%), and it is determined as a match if the match is greater than or equal to the threshold. In the case where the analysis results match (YES in step S905), the CPU 302 ends the process of generating a matching inspection region. In the case where the analysis results do not match, the CPU 302 saves the coordinates of the matching inspection candidate region along with the result that there is a discrepancy in the RAM 303. The CPU 302 proceeds to repeat the processing from step S904 onwards for candidate patterns at other predetermined coordinates.

The coordinate candidate patterns will now be described using FIG. 10C. For candidate patterns, the coordinate positions are determined based on the assumption that the data is arranged with regularity. Assume that an inspection region 1008 is set in step S902, which is at a position at which it is determined that there is a discrepancy in the analysis results in step S905, and let the center coordinates thereof be (x, y). In addition, let the coordinates of the upper-left corner of the image be (0, 0), and the coordinates of the lower-right corner be (X, Y). The center coordinates of a first candidate pattern 1009 are (X-x, y), the center coordinates of a second candidate pattern 1010 are (X-x, Y-y), and the center coordinates of a third candidate pattern 1011 are (x, Y-y).

In step S906, the CPU 302 retrieves the results from the RAM 303 to determine whether there are discrepancies in all of the candidate patterns 1009, 1010, and 1011. In the case where there are discrepancies in the results of all the candidate patterns (YES in step S906), the CPU 302 ends the process of generating a matching inspection region. At this time, the CPU 302 sets the matching inspection candidate region generated at first in step S902 as a matching inspection region, and ends the process. If there is a candidate pattern in which a discrepancy has not been determined yet (NO in step S906), the CPU 302 changes the position of the matching inspection candidate region in step S907.

In step S908, the CPU 302 determines whether there is any overlap error with other inspection regions for the newly-set matching inspection candidate region. Specifically, when the print image inspection region and the data inspection region overlap, the CPU 302 determines the overlap and displays a warning (not illustrated) on the inspection settings screen 600. If no warning is issued (NO in step S908), the CPU 302 returns to step S904 to perform the process. If a warning is issued (YES in step S908), the CPU 302 saves the coordinates of the candidate pattern along with the result that there is a discrepancy in the RAM 303, and returns to step S906 to perform the process. So far, the flow of generating a matching inspection region in the second embodiment has been described.

According to the present embodiment, setting a matching inspection region taking print settings into consideration enables more accurate setting compared to the first embodiment. Additionally, by identifying candidate coordinates considering the regularity of the design and even conducting analysis, the likelihood of accurately setting a matching inspection region is increased. From the above, it is possible to reduce the operator's workload in configuring the settings of a matching inspection region. Third Embodiment

In the second embodiment, the method of generating a matching inspection region considering the print settings and layout has been described. Furthermore, conducting an analysis at the time of generating a matching inspection region enables improved accuracy at the time of the setting. However, the method in the second embodiment can only check a limited region within the image.

A third embodiment will describe a method for improving the accuracy of setting a matching inspection region and reducing manual settings configured by an operator by utilizing image search to more flexibly search for and set a matching inspection region from the entire image.

Hereinafter, portions of the third embodiment that are different from the first embodiment and second embodiment explained earlier will be described. Note that portions that are not described in detail are the same as those in the first embodiment and the second embodiment.

### Flow of Generating Matching Inspection Region

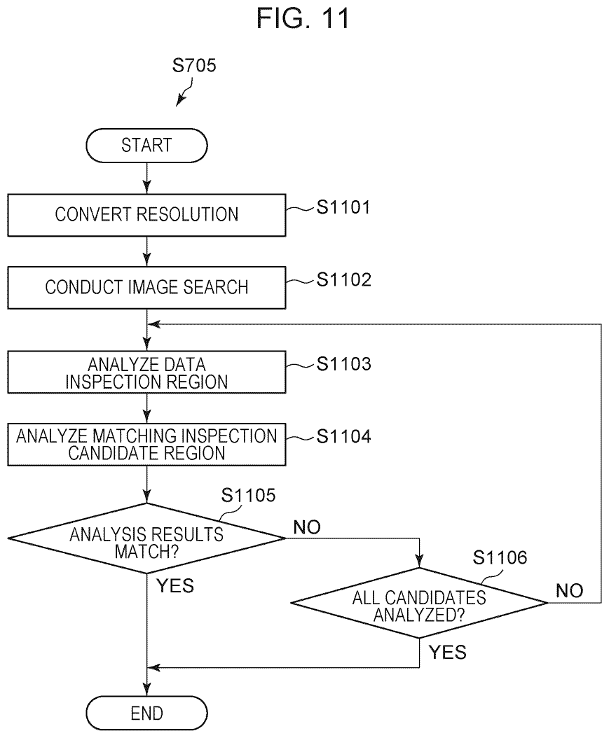

While the flow of configuring inspection settings in step S403 in the present embodiment is as indicated in the flowchart illustrated in FIG. 7, the flow of generating a matching inspection region in step S705, which is a feature of the present embodiment, will now be described using the flowchart illustrated in FIG. 11. This flowchart is realized by the CPU 302 of the inspection device 110 deploying program code stored in the ROM 304 to the RAM 303, and reading and executing the program code deployed in the RAM 303.

In step S1101, the CPU 302 performs a resolution conversion that reduces the resolution of a data inspection region and a back side image, and saves the converted image in the RAM 303. The reason for reducing the resolution is to reduce the load of the image search processing and speed up the processing. For example, if the resolution of an image registered as a reference image is 300 dpi, it is converted to 100 dpi using the bicubic method for resolution conversion. However, the method of resolution conversion is not limited to this, and it may be a general method as long as it does not significantly deteriorate the characteristics of the image. In addition, since the bicubic method is a general method, its detailed description is omitted.

Next, in step S1102, the CPU 302 retrieves the low-resolution image saved in the RAM 303 and performs image search. Image search, for example, utilizes the structure similarity (SSIM) method to search for regions on the back side image that have high similarity with the data inspection region. However, the method of image search is not limited to this, and other methods such as the peak signal to noise ratio (PSNR) method may be used. Note that SSIM is also a general method, and its detailed description is omitted. The specific method of image search involves calculating the evaluation values of SSIM while scanning a search region from the edge of the back side image, and sequentially saving them in a non-illustrated evaluation value list generated in the RAM 303. The evaluation value list is used to associate and save the coordinates of the search region in the low-resolution image with the evaluation value. When saving an evaluation value in the evaluation value list, the calculated value is compared with the value in the evaluation value list. If the calculated value is greater, it overwrites the value in the evaluation value list. When all searches within the image are completed, the evaluation value list is saved to ensure that one or more items of data will remain, ordered from highest to lowest evaluation value.

In step S1103, the CPU 302 analyzes the data inspection region of the original image registered as the reference image. In step S1104, the CPU 302 calculates the coordinates of the 300-dpi image registered as the reference image based on the coordinates in the evaluation value list, and analyzes the matching inspection candidate region of the original image registered as the reference image. Here, the coordinates retrieved from the evaluation value list are those with the highest evaluation value.

The analysis and determination here, in steps S1103 to S1105, are the same as step S903 to step S905 in the second embodiment, and their detailed description is omitted. In the case where the analysis result is determined as a “match”, (YES in step S1105), the CPU 302 ends the process of generating a matching inspection region, and deletes the evaluation value list from the RAM 303. In the case where it is determined that there is a discrepancy in the analysis results (NO in step S1105), in step S1106, the CPU 302 determines whether all candidates saved in the evaluation value list have been analyzed. In the case where all candidates have been analyzed (YES in step S1106), the CPU 302 ends the process of generating a matching inspection region, and deletes the evaluation value list from the RAM 303. At this time, the CPU 302 sets a matching inspection region at the same coordinates as the data inspection region, and ends the process. If there remains one or more candidates that have not been analyzed (NO in step S1106), the process from step S1103 to step S1105 is repeated for the coordinates with the next highest evaluation value in the evaluation value list. Note that, in the case where there are discrepancies in the analysis results of all candidates, the process may return to step S1101, and the same process may be performed at a higher resolution (such as 200 dpi). So far, the flow of generating a matching inspection region in the third embodiment has been described.

According to the present embodiment, searching for and setting a matching inspection region from the entire image by utilizing image search increases the likelihood of accurately setting a matching inspection region. From the above, it is possible to reduce the operator's workload in configuring the settings of a matching inspection region.

### Fourth Embodiment

In the third embodiment, the method of generating a matching inspection region by utilizing image search has been described. However, because it takes time to conduct image search and analysis, it may cause the operator to wait. Concern arises that an increase in the time required for the settings may actually lead to an increase in the operator's workload in configuring the settings.

A fourth embodiment will describe a method for reducing the operator's workload in configuring the settings of a matching inspection region by letting the operator specify the setting method at the beginning of setting a matching inspection region to more reliably set a matching inspection region in a shorter time.

Hereinafter, portions of the fourth embodiment that are different from the first to third embodiments explained earlier will be described. Note that portions that are not described in detail are the same as those in the first embodiment.

### Flow of Generating Matching Inspection Region

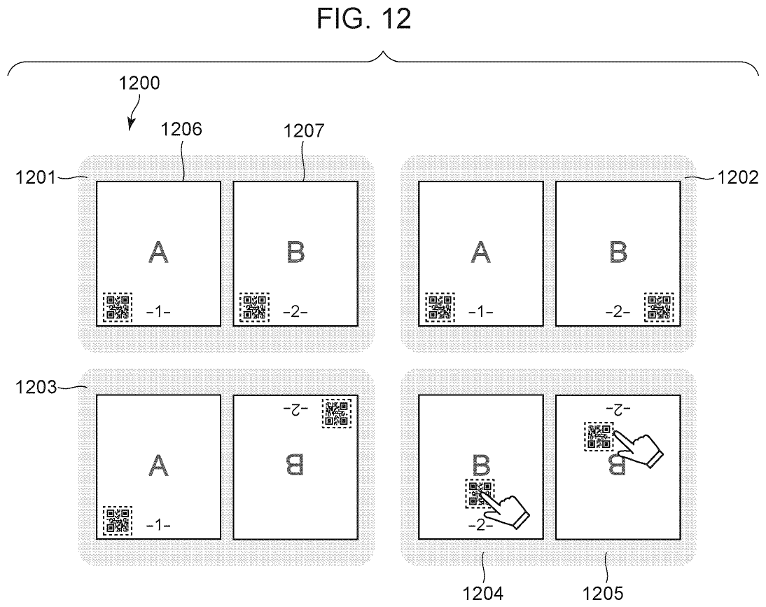

While the flow of configuring inspection settings in step S403 in the present embodiment is as indicated in the flowchart illustrated in FIG. 7, the flow of generating a matching inspection region in step S705, which is a feature of the present embodiment, will now be described using FIG. 12.

Reference numeral 1200 represents a selection screen for a matching inspection region setting method. The selection screen 1200 illustrates five setting methods, from 1201 to 1205. An image 1206 with the character “A” written is the front side image, and an image 1207 with the character “B” written is the back side image. Each image is surrounded by a dotted frame indicating that a QR code is an inspection region.

Reference numeral 1201 represents that the position and orientation settings of matching inspection regions on the front and back sides are the same. Reference numeral 1202 represents that the positions of matching inspection regions on the front and back sides are bilaterally symmetrical, while their orientation settings are the same.

Reference numeral 1203 represents that the positions of matching inspection regions on the front and back sides are radially symmetrical, and one of their orientation settings is rotated 180 degrees (their orientation settings differ by 180 degrees). Reference numeral 1204 represents that the positions of matching inspection regions on the front and back sides are manually set by the operator, while their orientation settings are the same.

Reference numeral 1205 represents that the positions of matching inspection regions on the front and back sides are manually set by the operator, and one of their orientation settings is rotated 180 degrees (their orientation settings differ by 180 degrees).

When generating a matching inspection region in step S705, the CPU 302 first displays the selection screen 1200 on the inspection settings screen 600. The display method may be a method of displaying it as an image in the region 605 or a method of displaying it as a radio button in the setting region 641. After the operator selects any of the setting methods 1201 to 1205, the CPU 302 generates and displays a matching inspection region in accordance with the selected setting method. For example, when the setting method 1202 is selected, the CPU 302 displays FIG. 8C in the region 605. Alternatively, when the setting method 1204 is selected, the CPU 302 displays FIG. 8B in the region 605. The process from S706 onwards is the same as the first embodiment.

So far, the flow of generating a matching inspection region in the fourth embodiment has been described.

According to the present embodiment, a matching inspection region can be more reliably set in a shorter time by letting the operator specify the method of setting a matching inspection region, thereby reducing the operator's workload in configuring the settings of a matching inspection region.

### Fifth Embodiment

In the first to fourth embodiments, the method of conducting a front-and-back matching inspection has been described. Also, there has been one matching inspection region on the front side, and one on the back side. However, in practice, multiple matching inspections occur within either the front or back side, or there may be three or more matching inspections, such as one on the front side and two on the back side.

A fifth embodiment will describe a method that accommodates cases not limited to the front and back sides, but also extends to situations with three or more matching inspection regions.

Hereinafter, portions of the fifth embodiment that are different from the first to fourth embodiments explained earlier will be described. Note that portions that are not described in detail are the same as those in the first embodiment.

### Flow of Generating Matching Inspection Region

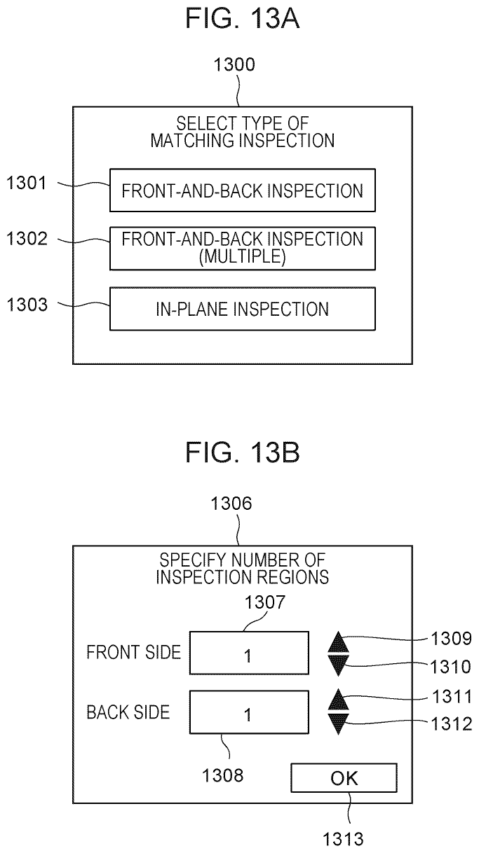

While the flow of configuring inspection settings in step S403 in the present embodiment is as indicated in the flowchart illustrated in FIG. 7, the flow of generating a matching inspection region in step S705, which is a feature of the present embodiment, will now be described using FIGS. 13A and 13B.

Reference numeral 1300 in FIG. 13A represents a selection screen for selecting the type of matching inspection, and reference numeral 1306 in FIG. 13B represents a detailed settings screen for configuring the details of matching inspection.

A front-and-back inspection button 1301 is a matching inspection selection button for setting one matching inspection region on the front side and one on the back side. A front-and-back inspection (multiple) button 1302 is a selection button for setting one matching inspection region on the front side, one on the back side, and additionally one or more on the front or/and back sides.

An in-plane inspection button 1303 is a matching inspection selection button for setting two or more matching inspection regions within the plane, either on the front side or the back side.

When generating a matching inspection region in step S705, the CPU 302 first displays the selection screen 1300 on the inspection settings screen 600. The display method may be a method of displaying it as an image in the region 605 or a method of displaying it as a radio button in the setting region 641.

If the front-and-back inspection button 1301 is selected, the CPU 302 generates one matching inspection region on the back side, and transitions to the processing in step S706. In this case, the method of generating a matching inspection region can be any of the methods explained previously.

If the front-and-back inspection (multiple) button 1302 is selected, the CPU 302 displays the detailed settings screen 1306 on the inspection settings screen 600.

A region 1307 is a window that displays the number of matching inspection regions to be set on the front side, with an initial value of “1”. A region 1308 is a window that displays the number of matching inspection regions to be set on the back side, with an initial value of “1”.

A triangle button 1309 is a button for increasing the numeral in the region 1307, and each time it is pressed, the CPU 302 increments the numeral in the region 1307 and displays the region 1307 again. A triangle button 1310 is a button for decreasing the numeral in the region 1307, and each time it is pressed, the CPU 302 decrements the numeral in the region 1307 and displays the region 1307 again.

A triangle button 1311 is a button for increasing the numeral in the region 1308, and each time it is pressed, the CPU 302 increments the numeral in the region 1308 and displays the region 1308 again. A triangle button 1312 is a button for decreasing the numeral in the region 1308, and each time it is pressed, the CPU 302 decrements the numeral in the region 1308 and displays the region 1308 again.

An OK button 1313 is an OK button for saving the settings on the detailed settings screen 1306 in the RAM 303 and transitioning to the inspection settings screen 600. After the OK button 1313 is pressed, the CPU 302 generates one or more inspection regions according to the number of matching inspection regions on the front and back sides saved in the RAM 303, and displays them in the region 605. At this time, all the settings of the matching inspection regions may be the same, but displaying the regions so that their positions do not overlap makes it easier for the operator to recognize the matching inspection regions.

If the in-plane inspection button 1303 is selected, the CPU 302 displays the detailed settings screen 1306 on the inspection settings screen 600. At that time, if the side displayed in the region 605 is the front side, the region 1308, the triangle button 1311, and the triangle button 1312 used for setting the back side are unnecessary, so they are grayed out. If the side displayed in the region 605 is the back side, the region 1307, the triangle button 1309, and the triangle button 1310 used for setting the front side are unnecessary, so they are grayed out. The process after the number of inspection regions on the front side or the back side is set and the OK button 1313 is pressed is as mentioned earlier.

So far, the flow of generating a matching inspection region in the fifth embodiment has been described.

According to the present embodiment, it is possible to set various cases of matching inspections, and to reduce the operator's workload in configuring the settings of matching inspection regions at that time.

### Other Embodiments

Thus far, various examples of the embodiments have been described. However, the essence and scope of the embodiments are not limited to specific descriptions within this specification.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-105938 filed Jun. 28, 2023, which is hereby incorporated by reference herein in its entirety.

What is claimed is:

1. An inspection device configured to inspect image data generated by a reading device, comprising:
a controller having one or more processors that execute instructions stored in one or more memories, the controller being configured to:
register received image data as reference image data;
on the reference image data registered, set a first region for conducting a matching inspection, and, upon receiving an instruction for a matching inspection, generate a second region having a same setting as the first region set;
on image data generated by the reading device from a printed material with image formed, extract data from a region corresponding to the first region and from a region corresponding to the second region; and
check whether the data extracted from the region corresponding to the first region matches the data extracted from the region corresponding to the second region.

2. The inspection device according to claim 1, wherein:
the controller is configured to check whether the data extracted from the region corresponding to the first region and the data extracted from the region corresponding to the second region match data prepared in advance.

3. The inspection device according to claim 1, wherein:
an inspection parameter is set for the first region, and the controller is configured to generate the second region having a same inspection parameter as the first region.

4. The inspection device according to claim 1, wherein:
the second region is generated within a same page as a page where the first region is set.

5. The inspection device according to claim 1, wherein:
the second region is generated on a page different from a page where the first region is set.

6. The inspection device according to claim 1, wherein:
the second region is generated on a different page of a same sheet as a page where the first region is set.

7. The inspection device according to claim 1, further comprising:
a display configured to display a screen,
wherein a setting change to the second region is accepted on the display.

8. The inspection device according to claim 1, further comprising:
a display configured to display a screen,
wherein the controller is configured to set the first region by accepting an operator's operation on a reference image displayed on the display.

9. The inspection device according to claim 1, further comprising:
a display configured to display a screen,
wherein, upon receiving an instruction for a matching inspection, a front side and a back side of a read image are displayed side by side on the display.

10. The inspection device according to claim 9 wherein:
the controller is configured to generate the second region with a same setting as the first region in response to selection of the first region displayed on the display and then an operation on a certain object indicating an instruction for a matching inspection.

11. A control method for an inspection device configured to inspect image data generated by a reading device, comprising:
registering received image data as reference image data;
on the reference image data registered, setting a first region for conducting a matching inspection;
upon receiving an instruction for a matching inspection, generating a second region having a same setting as the first region set; and
on read image data generated by the reading device from a printed material with image formed, conducting a matching inspection based on a region corresponding to the first region and a region corresponding to the second region.

12. The control method according to claim 11, further comprising:
extracting data from the region corresponding to the first region and the region corresponding to the second region,
wherein, in the conducting, it is checked whether the data extracted from the region corresponding to the first region matches the data extracted from the region corresponding to the second region.

13. An inspection system comprising:
an inspection unit configured to inspect image data generated by a reading unit; and
a controller having one or more processors that execute instructions stored in one or more memories, the controller being configured to:
register received image data as reference image data;
on the reference image data registered, set a first region for conducting a matching inspection, and, upon receiving an instruction for a matching inspection, generate a second region having a same setting as the first region set;
on image data generated by a reading device from a printed material with image formed, extract data from a region corresponding to the first region and from a region corresponding to the second region; and
check whether the data extracted from the region corresponding to the first region matches the data extracted from the region corresponding to the second region.

14. The inspection system according to claim 13, further comprising:
an image forming unit configured to form an image on paper; and
a conveyance unit configured to convey the paper with the image formed by the image forming unit,
wherein the reading unit is configured to read the image on the paper conveyed by the conveyance unit.

15. The inspection system according to claim 13, wherein:
the controller is configured to check whether the data extracted from the region corresponding to the first region and the data extracted from the region corresponding to the second region match data prepared in advance.

16. The inspection system according to claim 13, wherein:
an inspection parameter is set for the first region, and the controller is configured to generate the second region having a same inspection parameter as the first region.

17. The inspection system according to claim 13, wherein:
the second region is generated on a different page of a same sheet as a page where the first region is set.

18. The inspection system according to claim 13, further comprising:
a display configured to display a screen,
wherein a setting change to the second region is accepted on the display.

19. The inspection system according to claim 13, further comprising:
a display configured to display a screen,
wherein the controller is configured to set the first region by accepting an operator's operation on a reference image displayed on the display.

20. The inspection system according to claim 13, further comprising:
a display configured to display a screen,
wherein, upon receiving an instruction for a matching inspection, a front side and a back side of a read image are displayed side by side on the display.
